(19) United States
(12) Patent Application Publication
(10) Pub. No.: US 2021/0350170 A1
(43) Pub. Date: Nov. 11, 2021

(54) LOCALIZATION METHOD AND APPARATUS BASED ON SHARED MAP, ELECTRONIC DEVICE AND STORAGE MEDIUM

(71) Applicant: Zhejiang SenseTime Technology Development Co., Ltd., Hangzhou (CN)

(72) Inventors: Weijian Xie, Hangzhou (CN); Nan Wang, Hangzhou (CN); Quanhao Qian, Hangzhou (CN); Guofeng Zhang, Hangzhou (CN)

(21) Appl. No.: 17/383,663

(22) Filed: Jul. 23, 2021

Related U.S. Application Data
(63) Continuation of application No. PCT/CN2020/080465, filed on Mar. 20, 2020.

(30) Foreign Application Priority Data
Jun. 27, 2019 (CN) 201910569120.6

(51) Int. Cl. G06K 9/62; G06K 9/66; G06K 9/00

(52) U.S. Cl. CPC G06K 9/6211; G06K 9/00208; G06K 9/66; G06K 9/6206

(57) ABSTRACT

Related are a localization method and apparatus based on a shared map, an electronic device and a storage medium. The method includes that: from global map data, including at least one key frame, of an image collected by a first terminal, local map data associated with the key frame are extracted; a present frame in an image collected by a second terminal is acquired; and feature matching is performed on the present frame and the local map data, and a localization result for the present frame is obtained according to a matching result. With the adoption of the present disclosure, multiple moving terminals can be accurately localized to each other in the shared map.

### CROSS-REFERENCE TO RELATED APPLICATION

This is a continuation application of International Patent Application No. PCT/CN2020/080465, filed on Mar. 20, 2020, which claims priority to Chinese Patent Application No. 201910569120.6, filed to the National Intellectual Property Administration, PRC on Jun. 27, 2019 and entitled “Localization Method and Apparatus Based on Shared Map, Electronic Device and Storage Medium”. The disclosures of International Patent Application No. PCT/CN2020/080465 and Chinese Patent Application No. 201910569120.6 are hereby incorporated by reference in their entireties.

### BACKGROUND

Multiple terminals may move in respective coordinate systems and perform self-localization. With the development of localization technologies, the localization technology based on a shared map has broad application scenarios. For example, in an application scenario, Simultaneous Localization and Mapping (SLAM) is described as that a robot moves from an unknown position in an unknown environment, and performs self-localization during movement according to a position estimation and a map, thereby implementing self-localization and map sharing of the robot.

If multiple terminals share the same map, i.e., the multiple terminals move in the shared map and perform localization, how to accurately localize the multiple terminals relative to each other is a technical problem to be solved. However, effective solutions have not been proposed in the relevant art.

### SUMMARY

The present disclosure relates to the technical field of localization, and more particularly, to a method and apparatus for localization based on a shared map, an electronic device and a storage medium.

According to an aspect of the present disclosure, a localization method based on a shared map is provided, which may include the following operations.

From global map data, including at least one key frame, of an image collected by a first terminal, local map data associated with the key frame are extracted.

A present frame in an image collected by a second terminal is acquired.

Feature matching is performed on the present frame and the local map data, and a localization result for the present frame is obtained according to a matching result.

With the adoption of the present disclosure, the local map data associated with the key frame may be extracted from the global map data including the at least one key frame; and the local map data associated with the key frame include candidate frames most similar to the present frame and formed by multiple key frames, such that the data volume of key frames subjected to the feature matching with the present frame is increased and the accuracy of feature matching is also improved; and after the localization result for the present frame is obtained according to the matching result, multiple terminals move and are localized in the shared map according to the localization result to implement mutual accurate localization.

In a possible implementation, before the present frame in the image collected by the second terminal is acquired, the method may further include that: whether the number of feature points extracted from the present frame is smaller than an expected threshold for the feature matching is determined, and in a case where the number of feature points extracted from the present frame is smaller than the expected threshold, processing of supplementing feature points to the present frame is triggered.

With the adoption of the present disclosure, whether the number of feature points extracted from the present frame complies with the expected threshold for the feature matching may be determined, the feature points extracted from the present frame are used directly if yes, and the processing of supplementing the feature points to the present frame is triggered if no.

In a possible implementation, the present frame collected by the second terminal includes the present frame obtained by performing the processing of supplementing the feature points to the present frame.

With the adoption of the present disclosure, the present frame collected by the second terminal may be the present frame directly using the feature points extracted from the present frame, and may also be the present frame obtained by performing the processing of supplementing the feature points to the present frame. Thus, different feature point extraction manners are used according to an actual requirement.

In a possible implementation, the operation that the processing of supplementing the feature points to the present frame is executed may include the following operations.

A first screening threshold for performing feature point extraction on the present frame is acquired.

The first screening threshold is adaptively adjusted according to reference information to obtain a second screening threshold, and feature points are supplemented to the present frame according to the second screening threshold, such that the number of feature points is greater than the number of feature points acquired by actual collection.

With the adoption of the present disclosure, after the processing of supplementing the feature points to the present frame is triggered, the screening threshold may be adaptively adjusted, and the feature points are supplemented to the present frame according to the adjusted screening threshold, such that the number of feature points is greater than the number of feature points acquired by the actual collection. Thus, more feature points are used for the feature matching to achieve more accurate matching effects.

In a possible implementation, the reference information includes at least one of: information in environmental information for image collection, parameter information in an image collection device, or image information of the present frame itself.

With the adoption of the present disclosure, as the adaptive adjustment of the screening threshold is susceptible to any external information or the own information of the present frame, by taking at least one situation into considerations, the feature points are subsequently supplemented to the present frame according to the adjusted screening threshold, such that the number of feature points is greater than the number of feature points acquired by the actual collection. Thus, more feature points are used for the feature matching to achieve more accurate matching effects.

In a possible implementation, the operation that the feature matching is performed on the present frame and the local map data, and the localization result for the present frame is obtained according to the matching result may include the following operations.

Two-Dimensional (2D) feature matching of feature points is performed on the present frame and at least one key frame in the local map data to obtain a 2D feature matching result.

A 2D feature matching result including Three-Dimensional (3D) information is screened from the 2D feature matching result, and the 3D information is extracted.

A pose of the present frame is obtained according to the 3D information, the pose of the present frame serving as the localization result.

With the adoption of the present disclosure, the 2D-to-2D feature matching of the feature points is performed on the present frame and the at least one key frame in the local map data, i.e., a space in a 2D space is determined. As the pose includes an orientation and a displacement, the displacement may be described by the position in the 2D space, and to determine the form of orientation further needs 3D information, the 3D feature matching result including the 3D information needs to be screened from the 2D feature matching result and the 3D information is extracted, and thus the pose of the present frame is obtained according to the 3D information. By taking the pose of the present frame as the localization result, the multiple terminals move and are localized in the shared map according to the localization result to implement the mutual accurate localization.

According to an aspect of the present disclosure, a localization method based on a shared map is provided, which may include the following operations.

A first terminal collects an image to obtain global map data including at least one key frame.

The first terminal extracts local map data associated with the key frame from the global map data.

The first terminal receives the present frame collected by a second terminal, performs feature matching on the present frame and the local map data, obtains a localization result for the present frame according to a matching result, and sends the localization result.

With the adoption of the present disclosure, the global map data including the at least one key frame are obtained by means of collection of the first terminal; and the localization at the first terminal side is specifically to extract the local map data associated with the key frame from the global map data, perform the feature matching on the present frame acquired by the second terminal and the local map data, obtain the localization result for the present frame according to the matching result, and send the localization result to the second terminal. As the local map data associated with the key frame may be extracted from the global map data including the at least one key frame, multiple terminals move and are localized in the shared map according to the localization result to implement the mutual accurate localization.

In a possible implementation, the operation that the first terminal extracts the local map data associated with the key frame from the global map data may include the following operation.

With the key frame as a reference center, map data obtained according to the key frame and a preset extraction range are taken as the local map data.

With the adoption of the present disclosure, the data extracted with the key frame as the reference center within a predetermined range certainly are the local map data associated with the key frame; and by jointly taking the key frame and the associated local map data as information matched with the present frame, the data volume of the feature point matching is improved, and more accurate matching effect may be obtained.

In a possible implementation, the operation that the feature matching is performed on the present frame and the local map data, and the localization result for the present frame is obtained according to the matching result may include the following operations.

2D feature matching of feature points is performed on the present frame and at least one key frame in the local map data to obtain a 2D feature matching result.

A 2D feature matching result including 3D information is screened from the 2D feature matching result, and the 3D information is extracted.

A pose of the present frame is obtained according to the 3D information, the pose of the present frame serving as the localization result.

With the adoption of the present disclosure, the 2D-to-2D feature matching of the feature points is performed on the present frame and the at least one key frame in the local map data, i.e., a space in a 2D space is determined. As the pose includes an orientation and a displacement, the displacement may be described by the position in the 2D space, and to determine the form of orientation further needs 3D information, the 3D feature matching result including the 3D information needs to be screened from the 2D feature matching result and the 3D information is extracted, and thus the pose of the present frame is obtained according to the 3D information. By taking the pose of the present frame as the localization result, the multiple terminals move and are localized in the shared map according to the localization result to implement the mutual accurate localization.

According to an aspect of the present disclosure, a localization method based on a shared map is provided, which may include the following operations.

A second terminal collects an image to obtain the present frame in the collected image and sends the present frame.

The second terminal receives a localization result, the localization result being a result obtained according to a matching result after a first terminal performs feature matching on the present frame and local map data associated with the key frame.

Global map data are map data including at least one key frame in an image collected by the first terminal and having a data volume greater than that of the local map data.

With the adoption of the present disclosure, when the localization is performed at the first terminal side, multiple terminals move and are localized in the shared map according to the localization result to implement the mutual accurate localization. Further, processing of supplementing feature points to the present frame is performed at the second terminal. By supplementing the feature points to the present frame, the data of feature points for the feature matching are increased, and the accuracy of feature matching is also improved.

In a possible implementation, before the second terminal collects the image to obtain the present frame in the collected image, the method may further include that: whether the number of feature points extracted from the present frame is smaller than an expected threshold for the feature matching is determined, and in a case where the number of feature points extracted from the present frame is smaller than the expected threshold, processing of supplementing feature points to the present frame is triggered.

With the adoption of the present disclosure, whether the number of feature points extracted from the present frame complies with the expected threshold for the feature matching may be determined, the feature points extracted from the present frame are used directly if yes, and the processing of supplementing the feature points to the present frame is triggered if no.

In a possible implementation, the present frame collected by the second terminal includes the present frame obtained by performing the processing of supplementing the feature points to the present frame.

With the adoption of the present disclosure, the present frame collected by the second terminal may be the present frame directly using the feature points extracted from the present frame, and may also be the present frame obtained by performing the processing of supplementing the feature points to the present frame. Thus, different feature point extraction manners are used according to an actual requirement.

In a possible implementation, the operation that the processing of supplementing the feature points to the present frame is executed may include the following operations.

A first screening threshold for performing feature point extraction on the present frame is acquired.

The first screening threshold is adaptively adjusted according to reference information to obtain a second screening threshold, and feature points are supplemented to the present frame according to the second screening threshold, such that the number of feature points is greater than the number of feature points acquired by actual collection.

With the adoption of the present disclosure, after the processing of supplementing the feature points to the present frame is triggered, the screening threshold may be adaptively adjusted, and the feature points are supplemented to the present frame according to the adjusted screening threshold, such that the number of feature points is greater than the number of feature points acquired by the actual collection. Thus, more feature points are used for the feature matching to achieve more accurate matching effects.

In a possible implementation, the reference information includes at least one of: information in environmental information for image collection, parameter information in an image collection device, or image information of the present frame itself.

With the adoption of the present disclosure, as the adaptive adjustment of the screening threshold is susceptible to any external information or the own information of the present frame, by taking at least one situation into considerations, the feature points are subsequently supplemented to the present frame according to the adjusted screening threshold, such that the number of feature points is greater than the number of feature points acquired by the actual collection. Thus, more feature points are used for the feature matching to achieve more accurate matching effects.

According to an aspect of the present disclosure, a localization method based on a shared map is provided, which may include the following operations.

A second terminal receives global map data including at least one key frame, and extracts local map data associated with the key frame from the global map data.

The second terminal collects an image to obtain the present frame in the collected image.

The second terminal performs feature matching on the present frame and the local map data, and obtains a localization result for the present frame according to a matching result.

With the adoption of the present disclosure, the localization at the second terminal side is specifically to extract the local map data associated with the key frame from the global map data, perform the feature matching on the present frame acquired by the second terminal and the local map data, and obtain the localization result for the present frame according to the matching result. As the local map data associated with the key frame may be extracted from the global map data including the at least one key frame, multiple terminals move and are localized in the shared map according to the localization result to implement the mutual accurate localization.

In a possible implementation, before the second terminal collects the image to obtain the present frame in the collected image, the method may further include that: whether the number of feature points extracted from the present frame is smaller than an expected threshold for the feature matching is determined, and in a case where the number of feature points extracted from the present frame is smaller than the expected threshold, processing of supplementing feature points to the present frame is triggered.

With the adoption of the present disclosure, whether the number of feature points extracted from the present frame complies with the expected threshold for the feature matching may be determined, the feature points extracted from the present frame are used directly if yes, and the processing of supplementing the feature points to the present frame is triggered if no.

In a possible implementation, the present frame includes the present frame obtained by performing the processing of supplementing the feature points to the present frame.

With the adoption of the present disclosure, the present frame collected by the second terminal may be the present frame directly using the feature points extracted from the present frame, and may also be the present frame obtained by performing the processing of supplementing the feature points to the present frame. Thus, different feature point extraction manners are used according to an actual requirement.

In a possible implementation, the operation that the processing of supplementing the feature points to the present frame is executed may include the following operations.

A first screening threshold for performing feature point extraction on the present frame is acquired.

The first screening threshold is adaptively adjusted according to reference information to obtain a second screening threshold, and feature points are supplemented to the present frame according to the second screening threshold, such that the number of feature points is greater than the number of feature points acquired by actual collection.

With the adoption of the present disclosure, after the processing of supplementing the feature points to the present frame is triggered, the screening threshold may be adaptively adjusted, and the feature points are supplemented to the present frame according to the adjusted screening threshold, such that the number of feature points is greater than the number of feature points acquired by the actual collection. Thus, more feature points are used for the feature matching to achieve more accurate matching effects.

In a possible implementation, the reference information includes at least one of: information in environmental information for image collection, parameter information in an image collection device, or image information of the present frame itself.

With the adoption of the present disclosure, as the adaptive adjustment of the screening threshold is susceptible to any external information or the own information of the present frame, by taking at least one situation into considerations, the feature points are subsequently supplemented to the present frame according to the adjusted screening threshold, such that the number of feature points is greater than the number of feature points acquired by the actual collection. Thus, more feature points are used for the feature matching to achieve more accurate matching effects.

In a possible implementation, the operation that the feature matching is performed on the present frame and the local map data, and the localization result for the present frame is obtained according to the matching result may include the following operations.

2D feature matching of feature points is performed on the present frame and at least one key frame in the local map data to obtain a 2D feature matching result.

A 2D feature matching result including 3D information is screened from the 2D feature matching result, and the 3D information is extracted.

A pose of the present frame is obtained according to the 3D information, the pose of the present frame serving as the localization result.

With the adoption of the present disclosure, the 2D-to-2D feature matching of the feature points is performed on the present frame and the at least one key frame in the local map data, i.e., a space in a 2D space is determined. As the pose includes an orientation and a displacement, the displacement may be described by the position in the 2D space, and to determine the form of orientation further needs 3D information, the 3D feature matching result including the 3D information needs to be screened from the 2D feature matching result and the 3D information is extracted, and thus the pose of the present frame is obtained according to the 3D information. By taking the pose of the present frame as the localization result, the multiple terminals move and are localized in the shared map according to the localization result to implement the mutual accurate localization.

According to an aspect of the present disclosure, a localization method based on a shared map is provided, which may include the following operations.

Global map data including at least one key frame in an image collected by the first terminal are received, and local map data associated with the key frame are extracted from the global map data.

The present frame in an image collected by a second terminal is received.

Feature matching is performed on the present frame and the local map data, and a localization result for the present frame is obtained according to a matching result.

The localization result is sent.

With the adoption of the present disclosure, the localization is performed at a cloud terminal, and the localization is sent to the second terminal. As the local map data associated with the key frame may be extracted from the global map data including the at least one key frame, multiple terminals move and are localized in the shared map according to the localization result to implement the mutual accurate localization.

According to an aspect of the present disclosure, a localization apparatus based on a shared map is provided, which may include: a first extraction unit, a first acquisition unit and a first matching unit.

The first extraction unit is configured to extract, from global map data, comprising at least one key frame, of an image collected by a first terminal, local map data associated with the key frame.

The first acquisition unit is configured to acquire the present frame in an image collected by a second terminal.

The first matching unit is configured to perform feature matching on the present frame and the local map data, and obtain a localization result for the present frame according to a matching result.

In a possible implementation, the apparatus may further include: a trigger unit, configured to:

determine whether the number of feature points extracted from the present frame is smaller than an expected threshold for the feature matching, and trigger, in a case where the number of feature points extracted from the present frame is smaller than the expected threshold, processing of supplementing feature points to the present frame.

In a possible implementation, the apparatus may further include: a feature point supplementation unit, configured to:

acquire a first screening threshold for performing feature point extraction on the present frame; and

adaptively adjust the first screening threshold according to reference information to obtain a second screening threshold, and supplement feature points to the present frame according to the second screening threshold, such that the number of feature points is greater than the number of feature points acquired by actual collection.

According to an aspect of the present disclosure, a localization apparatus based on a shared map is provided, which may include: a first collection unit, a first extraction unit and a first matching unit.

The first collection unit is configured to collect an image to obtain global map data comprising at least one key frame.

The first extraction unit is configured to extract local map data associated with the key frame from the global map data.

The first matching unit is configured to receive the present frame collected by a second terminal, perform feature matching on the present frame and the local map data, obtain a localization result for the present frame according to a matching result, and send the localization result.

In a possible implementation, the first matching unit is further configured to:

perform 2D feature matching of feature points on the present frame and feature points on at least one key frame in the local map data to obtain a 2D feature matching result;

screen a 2D feature matching result including 3D information from the 2D feature matching result, and extract the 3D information; and

obtain a pose of the present frame according to the 3D information, the pose of the present frame serving as the localization result.

According to an aspect of the present disclosure, a localization apparatus based on a shared map is provided, which may include: a second collection unit and a second matching unit.

The second collection unit is configured to collect an image to obtain the present frame in the collected image and send the present frame.

The second matching unit is configured to receive a localization result, the localization result being a result obtained according to a matching result after a first terminal performs feature matching on the present frame and local map data associated with the key frame.

Global map data are map data including at least one key frame in an image collected by the first terminal and having a data volume greater than that of the local map data.

In a possible implementation, the apparatus may further include: a feature point supplementation unit, configured to:

acquire a first screening threshold for performing feature point extraction on the present frame; and

adaptively adjust the first screening threshold according to reference information to obtain a second screening threshold, and supplement feature points to the present frame according to the second screening threshold, such that the number of feature points is greater than the number of feature points acquired by actual collection.

According to an aspect of the present disclosure, a localization apparatus based on a shared map is provided, which may include: a second extraction unit, a second collection unit and a second matching unit.

The second extraction unit is configured to receive global map data including at least one key frame, and extract local map data associated with the key frame from the global map data.

The second collection unit is configured to collect an image to obtain the present frame in the collected image.

The second matching unit is configured to perform feature matching on the present frame and the local map data, and obtain a localization result for the present frame according to a matching result.

According to an aspect of the present disclosure, a localization apparatus based on a shared map is provided, which may include: a first receiving unit, a second receiving unit, a third matching unit and a third localization unit.

The first receiving unit is configured to receive global map data, including at least one key frame, of an image collected by a first terminal, and extract local map data associated with the key frame from the global map data.

The second receiving unit is configured to receive the present frame in an image collected by a second terminal.

The third matching unit is configured to perform feature matching on the present frame and the local map data, and obtain a localization result for the present frame according to a matching result.

The third localization unit is configured to send the localization result.

According to an aspect of the present disclosure, an electronic device is provided, which may include:

a processor,

a memory configured to store an instruction executable for the processor.

The processor is configured to: execute the localization method based on the shared map.

According to an aspect of the present disclosure, a computer-readable storage medium is provided, which stores a computer program instruction thereon; and the computer program instruction is executed by a processor to implement the localization method based on the shared map.

According to an aspect of the present disclosure, a computer program is provided, which may include a computer-readable code; and when the computer-readable code runs in an electronic device, a processor in the electronic device executes the localization method based on the shared map.

In the embodiments of the present disclosure, from global map data, including at least one key frame, of an image collected by a first terminal, local map data associated with the key frame are extracted; the present frame in an image collected by a second terminal is acquired; and feature matching is performed on the present frame and the local map data, and a localization result for the present frame is obtained according to a matching result. With the adoption of the present disclosure, in the process when the feature matching is performed on the present frame and the key frame, the local map data associated with the key frame are extracted from the global map data including the at least one key frame; and the local map data associated with the key frame include candidate frames most similar to the present frame and formed by multiple key frames, such that the data volume of key frames subjected to the feature matching with the present frame is increased and the accuracy of feature matching is also improved; and the localization result for the present frame is obtained according to the matching result, multiple terminals (which include the first terminal and the second terminal, is not limited to one terminal and is merely for the purpose of referring) may move and may be localized in the shared map according to the localization result to implement mutual accurate localization.

It is to be understood that the above general descriptions and detailed descriptions below are only exemplary and explanatory and not intended to limit the present disclosure.

According to the following detailed descriptions on the exemplary embodiments with reference to the accompanying drawings, other characteristics and aspects of the present disclosure become apparent.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 illustrates a flowchart of a localization method based on a shared map according to an embodiment of the present disclosure.

FIG. 2 illustrates a flowchart of a localization method based on a shared map according to an embodiment of the present disclosure.

FIG. 3 illustrates a flowchart of a localization method based on a shared map according to an embodiment of the present disclosure.

FIG. 4 illustrates a flowchart of a localization method based on a shared map according to an embodiment of the present disclosure.

FIG. 5 illustrates a flowchart of a localization method based on a shared map according to an embodiment of the present disclosure.

FIG. 6 illustrates a schematic diagram of a process of supplementing feature points to a present frame according to an embodiment of the present disclosure.

FIG. 7 illustrates a schematic diagram of a process of localizing a pose of a present frame according to an embodiment of the present disclosure.

FIG. 8 illustrates a block diagram of a localization apparatus based on a shared map according to an embodiment of the present disclosure.

FIG. 9 illustrates a block diagram of an electronic apparatus according to an embodiment of the present disclosure.

FIG. 10 illustrates a block diagram of an electronic apparatus according to an embodiment of the present disclosure.

### DETAILED DESCRIPTION

Various exemplary embodiments, features and aspects of the present disclosure will be described below in detail with reference to the accompanying drawings. A same numeral in the accompanying drawings indicates a same or similar component. Although various aspects of the embodiments are illustrated in the accompanying drawings, the accompanying drawings are unnecessarily drawn according to a proportion unless otherwise specified.

As used herein, the word “exemplary” means “serving as an example, instance, or illustration”. Thus, any embodiment described herein as “exemplary” is not necessarily to be construed as preferred or advantageous over other embodiments.

The term “and/or” in this specification is only an association relationship for describing associated objects and represents that three relationships may exist. For example, A and/or B may represent the following three cases: only A exists, both A and B exist, and only B exists. In addition, the term “at least one type” herein represents any one of multiple types or any combination of at least two types in the multiple types, for example, at least one type of A, B and C may represent any one or multiple elements selected from a set formed by the A, the B and the C.

In addition, for describing the disclosure better, many specific details are presented in the following specific implementations. It is to be understood by those skilled in the art that the present disclosure may still be implemented even without some specific details. In some examples, methods, means, components and circuits known very well to those skilled in the art are not described in detail, to highlight the subject of the present disclosure.

With SLAM as an example, the SLAM problem may be described as: a robot moves from an unknown position in an unknown environment, performs self-localization in movement according to a position estimation and a map, and constructs an incremental map on the basis of the self-localization, thereby implementing self-localization and map sharing of the robot. When different robots need to share their positions in one scenario, the positions are shared by a map. Respective positions in the shared map are determined by the localization technology, thus determining a position relationship in real world. In the robot, Augmented Reality (AR) and Virtual Reality (VR), the localization technology based on the shared map has the broad application scenarios.

With different map construction methods, the obtained maps also have different features, and the corresponding localization technologies also change a lot. For example, the map constructed based on an SLAM system of a laser radar is dense point clouds. The point clouds are a mass of point sets for representing target spatial distributions and target surface features in the same spatial reference system. The localization is achieved mainly based on matching between two point clouds, i.e., feature matching between feature points corresponding to two point cloud data images. However, the laser radar has a high equipment cost, and has a large computational burden due to the localization technology based on point cloud alignment. Concerning the hardware device, the camera is much lower than the laser radar in cost. With the adoption of the camera and the vision-based localization method, image retrieval may be first performed to search the most similar key frame; and then, feature matching is performed on a present frame and the key frame, and a pose of the present frame is estimated according to a matching result.

The above localization technology, however, has the following problems: first, the number of feature points extracted from each frame of image is limited due to the restriction in computational performance or SLAM framework in most cases; or otherwise, the performance of the SLAM algorithm may be affected due to time-consuming extraction of the feature points, which may result in that the localization failure occurs easily in field-of-view changing or weak texture scenario. Second, in a case where the number of feature points carried by each frame of image is small, the localization based on the matching between two frames of images is easily prone to the localization failure due to the too few feature points of each image. With the adoption of the present disclosure, the policy in the following any aspect may be used, or the policies in the two aspects may be combined for use, so as to increase the data volume for feature matching, thereby improving the localization capability in the weak texture case, and fully using map information to improve the localization success rate.

Policy I: in a localization framework composed of a first terminal, a second terminal and a cloud terminal, and in a localization unit for localization (the localization unit may be located at the first terminal side, the second terminal side or the cloud terminal side), at least one key frame of image most similar to the present frame sent by the second terminal may be searched in a shared map sent by the first terminal and including at least one key frame, to obtain local point cloud information associated with the at least one key frame for feature matching; and the feature matching is not performed on all point cloud information. Thus, visual information of the shared map may be used fully, i.e., different from the feature matching on the present frame and the key frame, the feature matching is performed on the present frame and the local point cloud information associated with the key frame. It is apparent that the data volume for the feature matching is increased, and the localization success rate is also improved.

Policy II: the present frame is used for localization on a shared map; and according to adaptively supplemented feature points of an environment, the number of feature points extracted on the present frame is always located at a high figure, for example, the number of feature points extracted on the present frame is greater than the number of actual feature points of the present frame when the SLAM system is used for tracking. It is apparent that the data volume for the feature matching is increased, and the localization success rate is also improved.

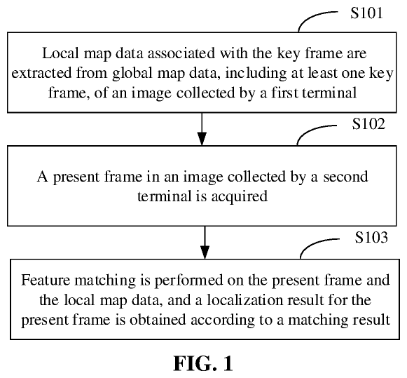

FIG. 1 illustrates a flowchart of a localization method based on a shared map according to an embodiment of the present disclosure. The localization method based on the shared map is applied to a localization apparatus based on the shared map. For example, the localization apparatus based on the shared map may be executed by a terminal device or a server or other processing devices. The terminal device may be User Equipment (UE), a mobile device, a cell phone, a cordless phone, a Personal Digital Assistant (PDA), a handheld device, a computing device, a vehicle-mounted device, a wearable device, etc. In some possible implementations, the localization method based on the shared map may be implemented by enabling a processor to call a computer-readable instruction stored in a memory. As shown in FIG. 1, the process may include the following steps.

In S101, from global map data, including at least one key frame, of an image collected by a first terminal, local map data associated with the key frame are extracted.

In an example, the local map data associated with the key frame may be local point cloud data associated with the key frame. The local point cloud data may select the key frame as a center. The key frame refers to a candidate frame most similar to the present frame.

In S102, the present frame in an image collected by a second terminal is acquired.

If the number of feature points in the present frame is greater than or equal to an expected threshold for feature matching, the feature matching is directly performed on the present frame and the local map data. If the number of feature points in the present frame is smaller than the expected threshold, processing of supplementing feature points to the present frame is triggered.

In S103, feature matching is performed on the present frame and the local map data, and a localization result for the present frame is obtained according to a matching result.

After S103, the method may further include that: a mutual position relationship in a case where the first terminal and the second terminal share the global map data is obtained according to the localization result.

With the adoption of the present disclosure, unlike the localization implemented by performing the feature matching on the present frame and the key frame, more feature points are used for the feature matching, for instance, the feature matching is performed on the present frame and the local point cloud data formed with the key frame as the center. Using the local point cloud data is to use more feature points, or use the local map to supplement a matching relationship between the present frame and the key frame, thereby achieving more accurate processing effect to implement accurate localization.

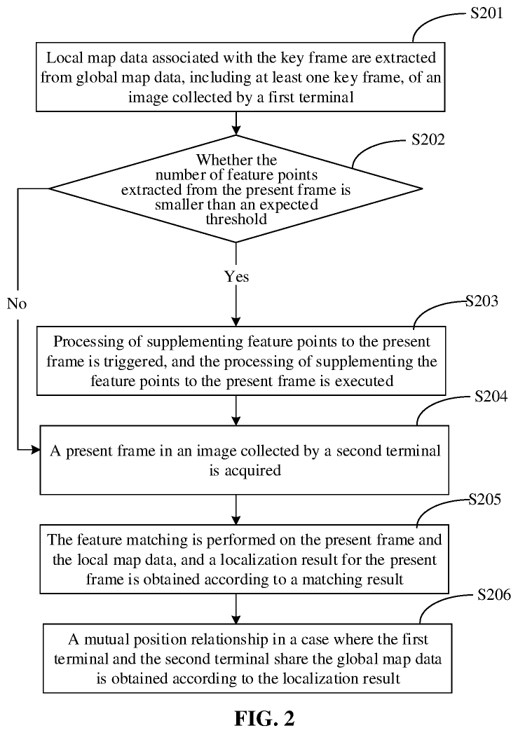

FIG. 2 illustrates a flowchart of a localization method based on a shared map according to an embodiment of the present disclosure. The localization method based on the shared map is applied to a localization apparatus based on the shared map. For example, the localization apparatus based on the shared map may be executed by a terminal device or a server or other processing devices. The terminal device may be UE, a mobile device, a cell phone, a cordless phone, a PDA, a handheld device, a computing device, a vehicle-mounted device, a wearable device, etc. In some possible implementations, the localization method based on the shared map may be implemented by enabling a processor to call a computer-readable instruction stored in a memory. As shown in FIG. 2, the process may include the following steps.

In S201, from global map data, including at least one key frame, of an image collected by a first terminal, local map data associated with the key frame are extracted.

In an example, the local map data associated with the key frame may be local point cloud data associated with the key frame. The local point cloud data may select the key frame as a center. The key frame refers to a candidate frame most similar to the present frame.

In S202, whether the number of feature points extracted from the present frame is smaller than an expected threshold for feature matching is determined, and if the number of feature points extracted from the present frame is smaller than the expected threshold, S203 is executed; or otherwise, S204 is executed.

In a case where the collected image has a weak texture, or the number of feature points carried by each frame of image is small, the above expected threshold is not reached.

In S203, processing of supplementing feature points to the present frame is triggered, and the processing of supplementing the feature points to the present frame is executed.

In an example, when the processing of supplementing the feature points to the present frame is executed, a feature point supplementation unit for supplementing the feature points to the present frame may be used. The feature point supplementation unit is located at the second terminal side that is configured to collect the present frame.

In S204, the present frame in an image collected by a second terminal is acquired.

If the number of feature points in the present frame is greater than or equal to the expected threshold for the feature matching, the present frame is the present frame obtained by collecting the image. If the number of feature points in the present frame is smaller than the expected threshold, the present frame is a present frame obtained by performing the processing of supplementing the feature points to the present frame.

In S205, the feature matching is performed on the present frame and the local map data, and a localization result for the present frame is obtained according to a matching result.

In S206, a mutual position relationship in a case where the first terminal and the second terminal share the global map data is obtained according to the localization result.

With the adoption of the present disclosure, different from localization implemented by comparing the present frame and the key frame, the present frame may be supplemented with the feature points, i.e., more feature points are compared to achieve more accurate processing effect to implement the accurate localization. In the relevant art, responsive to that the data volume of feature points in the present frame is consistent with the number of feature points actually obtained in self-tracking of the SLAM, the number of feature points extracted in the weak texture case may be decreased sharply. In the present disclosure, when the feature points of the present frame are extracted, the number of extracted points is greater than the number of feature points actually obtained in the self-tracking of the SLAM (may be two or more times of the number of feature points actually obtained in the self-tracking of the SLAM), and the feature points are supplemented in the weak texture case; and thus, the number of extracted feature points in the present frame is increased, and the localization success rate is improved. Moreover, the threshold for the extracted points is modified adaptively, thereby enhancing the feature point extraction ability in the weak texture case.

In an example, two terminals (mobile phones) are localized based on the shared map; and two users respectively hold one to play an AR game at the same table. The two mobile phones can observe the same AR effect and interact with each other, which requires that the two terminals are located in a coordinate system and know a pose to each other; and sharing their poses needs to implement mutual localization based on the shared map. Specifically, the first terminal (mobile phone 1) collects an image to obtain global map data including at least one key frame. Local map data (such as local point cloud data) associated with the key frame are extracted from the global map data. The local point cloud data may select the key frame (a candidate most similar to the present frame) as a center. The second terminal (mobile phone 2) collects an image to obtain the present frame. If the number of feature points in the present frame is greater than or equal to an expected threshold for feature matching, the feature matching is directly performed on the present frame and the local map data. If the number of feature points in the present frame is smaller than the expected threshold, processing of supplementing feature points to the present frame is triggered, i.e., extracted points (or called supplemented feature points) may be supplemented to the present frame. Further, the threshold for the extracted points may further be adaptively adjusted to obtain more feature points. The feature matching is performed on the present frame (or the present frame obtained after the feature points are supplemented) and the local point cloud data, and a local map is used to supplement a matching relationship between the present frame and the key frame to improve the localization success rate. A localization result for the present frame is obtained according to the matching result, and a mutual position relationship in a case where the first terminal (mobile phone 1) and the second terminal (mobile phone 2) share the global map data is obtained according to the localization result. Sharing means that the first terminal (mobile phone 1) and the second terminal (mobile phone 2) may localize, in the same coordinate system where the map is located, mutual positions or poses or the like in the same coordinate system.

In a possible implementation of the present disclosure, the operation that the processing of supplementing the feature points to the present frame may include that: a first screening threshold for performing feature point extraction on the present frame is acquired; the first screening threshold is adaptively adjusted according to reference information to obtain a second screening threshold; and feature points are supplemented to the present frame according to the second screening threshold, such that the number of feature points is greater than the number of feature points acquired by actual collection. The reference information includes at least one of: information in environmental information for image collection, parameter information in an image collection device, or image information of the present frame itself. Specifically, 1) the environmental information may be a first influencing factor causing the insufficient number of extracted feature points: for example, at least one type of information such as an illumination condition and surrounding blocking, and is not limited to influencing information causing at least one situation where the number of feature points is less or reduced. 2) The parameter information in the image collection device may be sensor parameter information and is a second influencing factor causing the insufficient number of extracted feature points, such as sensitivity, definition, exposure, contrast and the like for sensor collection of a camera. 3) The image information of the present frame itself is one of own influencing factors causing the insufficient number of extracted feature points, for example, some images have few textures and are simple; and correspondingly, there may be a few of feature points that can be extracted.

In a possible implementation of the present disclosure, the operation that the feature matching is performed on the present frame and the local map data, and the localization result for the present frame is obtained according to the matching result may include that: 2D feature matching of feature points is performed on the present frame and at least one key frame in the local map data to obtain a 2D feature matching result. A 2D feature matching result including 3D information is screened from the 2D feature matching result, and the 3D information is extracted. A pose of the present frame is obtained according to the 3D information, the pose of the present frame serving as the localization result. Specifically, upon the 2D-to-2D feature matching of the feature points, the 2D feature matching result including the 3D information (called a screening result) may be obtained by screening, and the pose of the present frame may be obtained according to the screening result.

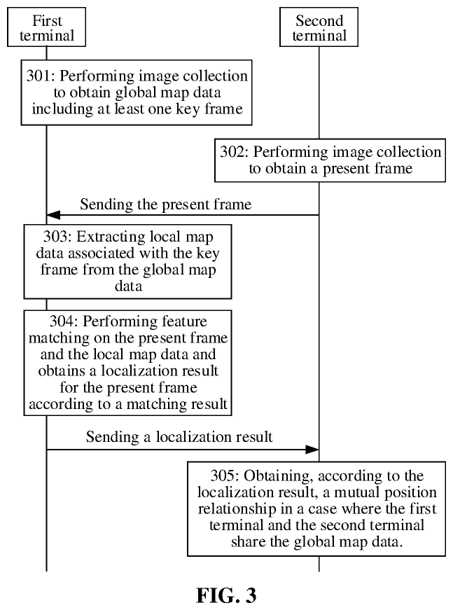

FIG. 3 illustrates a flowchart of a localization method based on a shared map according to an embodiment of the present disclosure. The localization method based on the shared map is applied to a localization apparatus based on the shared map. For example, the localization apparatus based on the shared map may be executed by a terminal device or a server or other processing devices. The terminal device may be UE, a mobile device, a cell phone, a cordless phone, a PDA, a handheld device, a computing device, a vehicle-mounted device, a wearable device, etc. In some possible implementations, the localization method based on the shared map may be implemented by enabling a processor to call a computer-readable instruction stored in a memory. The localization unit may be located at the first terminal side. As shown in FIG. 3, the process may include the following steps.

In S301, the first terminal collects an image to obtain global map data including at least one key frame.

In S302, the second terminal collects an image to obtain the present frame in the collected image and sends the present frame to the first terminal.

In S303, the first terminal extracts local map data associated with the key frame from the global map data.

In an example, the global map data are map data including at least one key frame in the image collected by the first terminal and having a data volume greater than that of the local map data.

In S304, the first terminal receives the present frame collected by the second terminal, performs feature matching on the present frame and the local map data, obtains a localization result for the present frame according to a matching result, and sends the localization result to the second terminal.

In S305, the second terminal obtains, according to the localization result, a mutual position relationship in a case where the first terminal and the second terminal share the global map data.

In a possible implementation of the present disclosure, the operation that the first terminal extracts the local map data associated with the key frame from the global map data may include that: with the key frame as a reference center, map data obtained according to the key frame and a preset extraction range are taken as the local map data.

In a possible implementation of the present disclosure, the operation that the feature matching is performed on the present frame and the local map data, and the localization result for the present frame is obtained according to the matching result may include that: 2D feature matching of feature points is performed on the present frame and at least one key frame in the local map data to obtain a 2D feature matching result; a 2D feature matching result including 3D information is screened from the 2D feature matching result, and the 3D information is extracted; and a pose of the present frame is obtained according to the 3D information, the pose of the present frame serving as the localization result. Specifically, upon the 2D-to-2D feature matching of the feature points, the 2D feature matching result including the 3D information (called a screening result) may be obtained by screening, and the pose of the present frame may be obtained according to the screening result.

In a possible implementation of the present disclosure, the method may further include that: before the terminal collects the image to obtain the present frame in the collected image, whether the number of feature points extracted from the present frame is smaller than an expected threshold for the feature matching is determined, and in a case where the number of feature points extracted from the present frame is smaller than the expected threshold, processing of supplementing feature points to the present frame is triggered. The present frame collected by the second terminal includes the present frame obtained by performing the processing of supplementing the feature points to the present frame. In an example, a first screening threshold for performing feature point extraction on the present frame is acquired; the first screening threshold is adaptively adjusted according to reference information to obtain a second screening threshold; and feature points are supplemented to the present frame according to the second screening threshold. When the number of feature points is greater than the number of feature points acquired by actual collection, the processing of supplementing the feature points to the present frame may be ended.

In a possible implementation of the present disclosure, the reference information includes at least one of: information in environmental information for image collection, parameter information in an image collection device, or image information of the present frame itself.

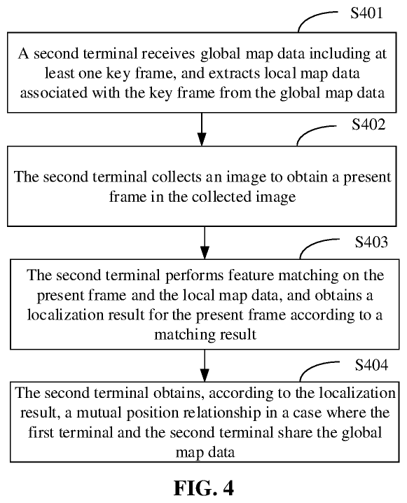

FIG. 4 illustrates a flowchart of a localization method based on a shared map according to an embodiment of the present disclosure. The localization method based on the shared map is applied to a localization apparatus based on the shared map. For example, the localization apparatus based on the shared map may be executed by a terminal device or a server or other processing devices. The terminal device may be UE, a mobile device, a cell phone, a cordless phone, a PDA, a handheld device, a computing device, a vehicle-mounted device, a wearable device, etc. In some possible implementations, the localization method based on the shared map may be implemented by enabling a processor to call a computer-readable instruction stored in a memory. The localization unit may be located at the second terminal side. As shown in FIG. 4, the process may include the following steps.

In S401, a second terminal receives global map data including at least one key frame, and extracts local map data associated with the key frame from the global map data.

In S402, the second terminal collects an image to obtain the present frame in the collected image.

In S403, the second terminal performs feature matching on the present frame and the local map data, and obtains a localization result for the present frame according to a matching result.

In S404, the second terminal obtains, according to the localization result, a mutual position relationship in a case where the first terminal and the second terminal share the global map data.

In a possible implementation of the present disclosure, the method may further include that: before the terminal collects the image to obtain the present frame in the collected image, whether the number of feature points extracted from the present frame is smaller than an expected threshold for the feature matching is determined, and in a case where the number of feature points extracted from the present frame is smaller than the expected threshold, processing of supplementing feature points to the present frame is triggered. The present frame includes the present frame obtained by performing the processing of supplementing the feature points to the present frame.

In a possible implementation of the present disclosure, the operation that the processing of supplementing the feature points to the present frame may include that: a first screening threshold for performing feature point extraction on the present frame is acquired; the first screening threshold is adaptively adjusted according to reference information to obtain a second screening threshold; and feature points are supplemented to the present frame according to the second screening threshold, such that the number of feature points is greater than the number of feature points acquired by actual collection. The reference information includes at least one of: information in environmental information for image collection, parameter information in an image collection device, or image information of the present frame itself.

In a possible implementation of the present disclosure, the operation that the feature matching is performed on the present frame and the local map data, and the localization result for the present frame is obtained according to the matching result may include that: 2D feature matching of feature points is performed on the present frame and at least one key frame in the local map data to obtain a 2D feature matching result; a 2D feature matching result including 3D information is screened from the 2D feature matching result, and the 3D information is extracted; and a pose of the present frame is obtained according to the 3D information, the pose of the present frame serving as the localization result. Specifically, upon the 2D-to-2D feature matching of the feature points, the 2D feature matching result including the 3D information (called a screening result) may be obtained by screening, and the pose of the present frame may be obtained according to the screening result.

The localization method based on the shared map according to the embodiment of the present disclosure may be applied to a localization apparatus based on the shared map. For example, the localization apparatus based on the shared map may be executed by a terminal device or a server or other processing devices. The terminal device may be UE, a mobile device, a cell phone, a cordless phone, a PDA, a handheld device, a computing device, a vehicle-mounted device, a wearable device, etc. In some possible implementations, the localization method based on the shared map may be implemented by enabling a processor to call a computer-readable instruction stored in a memory. The localization unit may be located at the cloud terminal. The process may include that: global map data including at least one key frame in an image collected by the first terminal are received, and local map data associated with the key frame are extracted from the global map data. The present frame in an image collected by a second terminal is received. Feature matching is performed on the present frame and the local map data, and a localization result for the present frame is obtained according to a matching result. The localization result is sent, so as to obtain, according to the localization result, a mutual position relationship in a case where the first terminal and the second terminal share the global map data.

### Application Examples

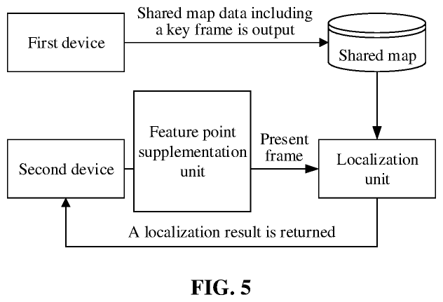

FIG. 5 illustrates a localization method based on a shared map according to an embodiment of the present disclosure. The method uses two terminal devices (a first device and a second device) as an example, and is not limited to the illustrated two terminal devices. The localization may also be performed among multiple terminal devices through the shared map. As shown in FIG. 5, the localization process may include that: the first device scans a scenario to generate a map at least including a key frame. The map is defined as the shared map. The shared map may be stored to the first device locally or uploaded to other terminal devices (such as the second device), and may further stored to the cloud terminal. One or more devices (briefly labeled as the second device in the figure) having requirements on the shared map may send data of the present frame collected by the device to a localization unit. The localization unit may run in any device or may be located on the cloud terminal. In addition to the data of the present frame from the second device, the localization unit may further acquire shared map data. The localization unit may obtain a localization result for the present frame according to the present frame of image and the shared map data, and transmit the localization result back to the second device. By means of such a manner, the second device may obtain a relative pose relative to a coordinate system of the shared map.

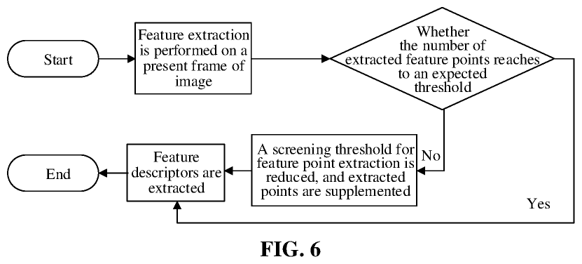

FIG. 6 illustrates a schematic diagram of a process of supplementing feature points to a present frame according to an embodiment of the present disclosure. The second device may adaptively adjust the present frame of image according to a feature point supplementation unit to supplement more feature points. As shown in FIG. 6, the process of supplementing the feature points to the present frame may include the following contents.

Input: present frame of image.

Output: feature points and descriptors (or called feature descriptors), the feature descriptor being a data structure for describing features, and any descriptor being multi-dimensional.

1. Feature point extraction is performed with default parameters on the present frame of image acquired by the second device. The number of extracted feature points may be doubled over the number of feature points actually acquired by the SLAM system.

2. The number of feature points extracted in S1 is checked; and if the number of feature points is smaller than a special expected threshold, a skip is made to S3; or otherwise, a skip is made to S4.

3. A screening threshold for the feature points is reduced, and the extracted points are supplemented (or the number of feature points in the present frame is supplemented).

4. Feature descriptors are extracted from the extracted feature points, and an extraction result is returned.

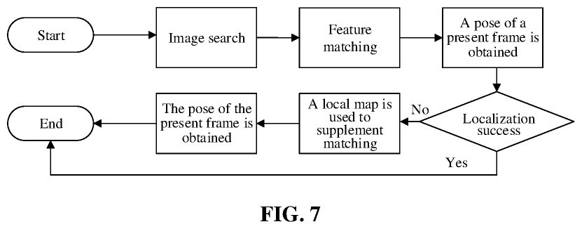

FIG. 7 illustrates a schematic diagram of a process of localizing a pose of a present frame according to an embodiment of the present disclosure. The localization process may be implemented by a localization unit. As shown in FIG. 7, the localization process may include the following contents.

Input: present frame of data, and shared map.

Output: localization result.

1. Image search is performed on the shared map by using feature information of the present frame, and a key frame, called as a candidate frame, most similar to the present frame of image is searched.

2. Feature matching is performed on the present frame and the candidate frame. As feature points on the candidate frame carry 3D information, a series of 2D-to-3D matching results may be obtained.

3. According to the matching results from the 2D feature points to the 3D points in S2, the pose of the present frame may be optimized and obtained.

4. Whether the pose obtained in S3 has enough interior points is determined; and if the number of interior points is smaller than a certain threshold, S5 is continued; or otherwise, a skip is made to S7.

Upon the 2D-to-2D feature matching of the feature points on the present frame and at least one key frame in the local point cloud data, the 2D feature matching result including the 3D information (called a screening result) may be obtained by screening, and the pose of the present frame may be obtained according to the screening result. It is to be noted that the screening result does not mean that all feature points therein are good in quality. The quality of each feature point is determined by whether that feature point is used for the feature matching. According to the qualities, the feature points may be divided into interior points and exterior points. The interior points refer to feature points with the good quality, and the exterior points refer to feature points with the insufficiently good quality.

It is to be noted that the above feature matching may involve a concept of multiple view geometry. The multiple view geometry refers to that a geometric method is used to restore a 3D object via a plurality of 2D images; in other words, the multiple view geometry is to research 3D reconstruction, and is mainly applied to computer vision. With the multiple view geometry, the computer not only can sense geometric information in a 3D environment including a shape, a position, a posture, a movement and the like, but also can describe, store, identify and understand then. In the computer vision, there is a need for finding a feature matching point between two frames of images. For example, for one frame of image in the two frames of images, 1000 feature points (2D) may be extracted according to image quality and texture information; and for the other frame of image in the two frames of images, 1000 feature points (2D) may also be extracted according to image quality and texture information. Feature point matching needs to be performed to find how the two images are correlated, for example, with the feature point matching on the two frames of images, 600 feature points are correlated. The most important feature of each feature point is that the feature point has an ability of uniquely identifying image information. As the object is moving and has a displacement, information (such as 3D information included in the 2D feature points) described by the feature points in the two frames of images may vary from each other; or the multiple view geometry is used for perform multi-view observation. From another viewing angle, with different angles, the information (such as the 3D information included in the 2D feature points) described by the feature points may be different or even image blocking or distortion and other extreme situations may occur to result in not all 2D feature points include the 3D information, or include applicable 3D information. For example, only 300 2D feature points of the 600 feature points include the 3D information. Thus, the 2D feature matching result (a screening result) including the 3D information may be screened, and the pose of the present frame is obtained according to the screening result, thereby obtaining more accurate localization.

5. On the basis of the candidate frame obtained in S1, at least one frame having a common-view relationship with the candidate frame is selected as the key frame. Point cloud sets included in the key frames are used as local map data (or called local point cloud data); and the pose obtained in S3 is used as an initial pose for supplementary matching.

6. The pose of the present frame is optimized and obtained according to a matching result in S5 and a localization result is returned.

It may be understood by the person skilled in the art that in the method of the specific implementations, the writing sequence of each step does not mean a strict execution sequence to form any limit to the implementation process, and the specific execution sequence of each step may be determined in terms of the function and possible internal logic.

The method embodiments mentioned in the present disclosure may be combined with each other to form a combined embodiment without departing from the principle and logic, which is not elaborated in the embodiments of the present disclosure for the sake of simplicity.

In addition, the present disclosure further provides a localization apparatus based on a shared map, an electronic device, a computer-readable storage medium and a program, all of which may be configured to implement any localization method based on the shared map provided by the present disclosure. The corresponding technical solutions and descriptions refer to the corresponding descriptions in the method and will not be elaborated herein.

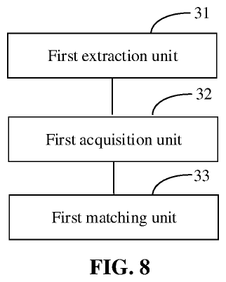

FIG. 8 illustrates a block diagram of a localization apparatus based on a shared map according to an embodiment of the present disclosure. As shown in FIG. 8, the localization apparatus based on the shared map in the embodiment of the present disclosure may include: a first extraction unit 31, configured to extract, from global map data, comprising at least one key frame, of an image collected by a first terminal, local map data associated with the key frame; a first acquisition unit 32, configured to acquire the present frame in an image collected by a second terminal; and a first matching unit 33, configured to perform feature matching on the present frame and the local map data, and obtain a localization result for the present frame according to a matching result. The apparatus may further include: a first localization unit, configured to obtain, according to the localization result, a mutual position relationship in a case where the first terminal and the second terminal share the global map data.

In a possible implementation of the present disclosure, the apparatus may further include: a trigger unit, configured to: determine whether the number of feature points extracted from the present frame is smaller than an expected threshold for the feature matching, and trigger, in a case where the number of feature points extracted from the present frame is smaller than the expected threshold, processing of supplementing feature points to the present frame.

In a possible implementation of the present disclosure, the present frame collected by the second terminal includes the present frame obtained by performing the processing of supplementing the feature points to the present frame.

In a possible implementation of the present disclosure, the apparatus may further include: a feature point supplementation unit, configured to: acquire a first screening threshold for performing feature point extraction on the present frame; adaptively adjust the first screening threshold according to reference information to obtain a second screening threshold; and supplement feature points to the present frame according to the second screening threshold, such that the number of feature points is greater than the number of feature points acquired by actual collection.

In a possible implementation of the present disclosure, the reference information includes at least one of: information in environmental information for image collection, parameter information in an image collection device, or image information of the present frame itself.

In a possible implementation of the present disclosure, the first matching unit is further configured to: perform 2D feature matching of feature points on the present frame and feature points on at least one key frame in the local map data to obtain a 2D feature matching result; screen a 2D feature matching result including 3D information from the 2D feature matching result, and extract the 3D information; and obtain a pose of the present frame according to the 3D information, the pose of the present frame serving as the localization result.

The localization apparatus based on the shared map according to the embodiment of the present disclosure may include: a first collection unit, configured to collect an image to obtain global map data comprising at least one key frame; a first extraction unit, configured to extract local map data associated with the key frame from the global map data; and a first matching unit, configured to receive the present frame collected by a second terminal, perform feature matching on the present frame and the local map data, obtain a localization result for the present frame according to a matching result, and send the localization result.

In a possible implementation of the present disclosure, the first extraction unit is further configured to: take, with the key frame as a reference center, map data obtained according to the key frame and a preset extraction range as the local map data.

In a possible implementation of the present disclosure, the first matching unit is further configured to: perform 2D feature matching of feature points on the present frame and feature points on at least one key frame in the local map data to obtain a 2D feature matching result; screen a 2D feature matching result including 3D information from the 2D feature matching result, and extract the 3D information; and obtain a pose of the present frame according to the 3D information, the pose of the present frame serving as the localization result.

The localization apparatus based on the shared map according to the embodiment of the present disclosure may include: a second collection unit, configured to collect an image to obtain the present frame in the collected image and send the present frame; a second matching unit, configured to receive a localization result, the localization result being a result obtained according to a matching result after a first terminal performs feature matching on the present frame and local map data associated with the key frame; and a second localization unit, configured to obtain, according to the localization result, a mutual position relationship in a case where the first terminal and the second terminal share the global map data. The global map data are map data including at least one key frame in an image collected by the first terminal and having a data volume greater than that of the local map data.

In a possible implementation of the present disclosure, the apparatus may further include: a trigger unit, configured to: determine whether the number of feature points extracted from the present frame is smaller than an expected threshold for the feature matching, and trigger, in a case where the number of feature points extracted from the present frame is smaller than the expected threshold, processing of supplementing feature points to the present frame.

In a possible implementation of the present disclosure, the present frame collected by the second terminal includes the present frame obtained by performing the processing of supplementing the feature points to the present frame.

In a possible implementation of the present disclosure, the apparatus may further include: a feature point supplementation unit, configured to: acquire a first screening threshold for performing feature point extraction on the present frame; adaptively adjust the first screening threshold according to reference information to obtain a second screening threshold; and supplement feature points to the present frame according to the second screening threshold, such that the number of feature points is greater than the number of feature points acquired by actual collection.

In a possible implementation of the present disclosure, the reference information includes at least one of: information in environmental information for image collection, parameter information in an image collection device, or image information of the present frame itself.

The localization apparatus based on the shared map according to the embodiment of the present disclosure may include: a second extraction unit, configured to receive global map data including at least one key frame, and extract local map data associated with the key frame from the global map data; a second collection unit, configured to collect an image to obtain the present frame in the collected image; a second matching unit, configured to perform feature matching on the present frame and the local map data, and obtain a localization result for the present frame according to a matching result; and a second localization unit, configured to obtain, according to the localization result, a mutual position relationship in a case where the first terminal and the second terminal share the global map data.

The apparatus according to the embodiment of the present disclosure may further include: a trigger unit, configured to: determine whether the number of feature points extracted from the present frame is smaller than an expected threshold for the feature matching, and trigger, in a case where the number of feature points extracted from the present frame is smaller than the expected threshold, processing of supplementing feature points to the present frame.

The present frame according to the embodiment of the present disclosure includes the present frame obtained by performing the processing of supplementing the feature points to the present frame.

The apparatus according to the embodiment of the present disclosure may further include: a feature point supplementation unit, configured to: acquire a first screening threshold for performing feature point extraction on the present frame; adaptively adjust the first screening threshold according to reference information to obtain a second screening threshold; and supplement feature points to the present frame according to the second screening threshold, such that the number of feature points is greater than the number of feature points acquired by actual collection.

The reference information according to the embodiment of the present disclosure includes at least one of: information in environmental information for image collection, parameter information in an image collection device, or image information of the present frame itself.

The second localization unit according to the embodiment of the present disclosure is further configured to: perform 2D feature matching of feature points on the present frame and feature points on at least one key frame in the local map data to obtain a 2D feature matching result; screen a 2D feature matching result including 3D information from the 2D feature matching result, and extract the 3D information; and obtain a pose of the present frame according to the 3D information, the pose of the present frame serving as the localization result.

The localization apparatus based on the shared map according to the embodiment of the present disclosure may include: a first receiving unit, configured to receive global map data, including at least one key frame, of an image collected by a first terminal, and extract local map data associated with the key frame from the global map data; a second receiving unit, configured to receive the present frame in an image collected by a second terminal; a third matching unit, configured to perform feature matching on the present frame and the local map data, and obtain a localization result for the present frame according to a matching result; and a third localization unit, configured to obtain, according to the localization result, a mutual position relationship in a case where the first terminal and the second terminal share the global map data.

In some embodiments, the function or included module of the apparatus provided by the embodiment of the present disclosure may be configured to execute the method described in the above method embodiments, and the specific implementation may refer to the description in the above method embodiments. For the simplicity, the details are not elaborated herein.

An embodiment of the present disclosure further provides a computer-readable storage medium, which stores a computer program instruction thereon; and the computer program instruction is executed by a processor to implement the localization method based on the shared map. The computer-readable storage medium may be a non-volatile computer-readable storage medium.

An embodiment of the present disclosure further provides an electronic device, which may include: a processor; and a memory configured to store an instruction executable for the processor, the processor being configured to execute the localization method based on the shared map.

The electronic device may be provided as a terminal, a server or other types of devices.

An embodiment of the present disclosure further provides a computer program, which may include a computer-readable code; and when the computer-readable code runs in an electronic device, a processor in the electronic device executes the localization method based on the shared map.

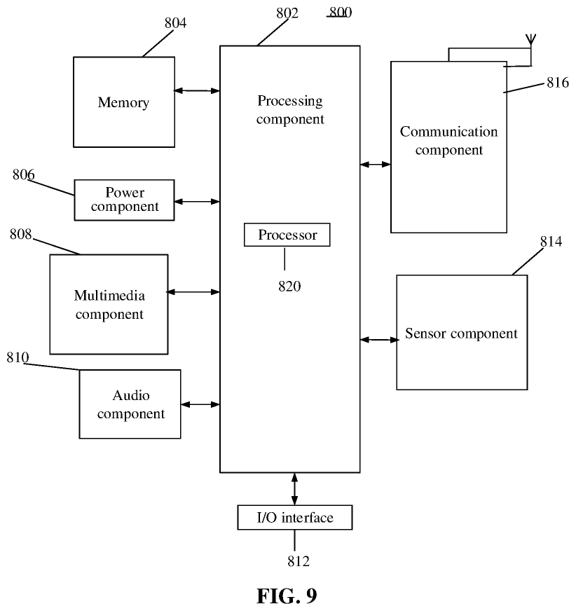

FIG. 9 illustrates a block diagram of an electronic apparatus 800 according to an exemplary embodiment. For example, the electronic device 800 may be a terminal such as a mobile phone, a computer, a digital broadcast terminal, a messaging device, a gaming console, a tablet, a medical device, exercise equipment and a PDA. At this time, the localization unit is located at any terminal side.

Referring to FIG. 9, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the electronic device 800. Examples of such data include instructions for any application or method operated on the electronic device 800, contact data, phonebook data, messages, pictures, videos, etc. The memory 804 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 806 provides power to various components of the electronic device 800. The power component 806 may include a power management system, one or more power sources, and any other components associated with the generation, management, and distribution of power in the electronic device 800.

The multimedia component 808 includes a screen providing an output interface between the electronic device 800 and the user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signal may further be stored in the memory 804 or transmitted via the communication component 816. In some embodiments, the audio component 810 further includes a speaker configured to output audio signals.

The I/O interface 812 provides an interface between the processing component 802 and peripheral interface modules. The peripheral interface modules may be a keyboard, a click wheel, buttons, and the like. The buttons may include, but are not limited to, a home button, a volume button, a starting button, and a locking button.

The sensor component 814 includes one or more sensors to provide status assessments of various aspects of the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor, configured to detect the presence of nearby objects without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In one exemplary embodiment, the communication component 816 receives a broadcast signal or broadcast associated information from an external broadcast management system via a broadcast channel In one exemplary embodiment, the communication component 816 further includes a near field communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

In an exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, a nonvolatile computer-readable storage medium, for example, a memory 804 including a computer program instruction, is also provided. The computer program instruction may be executed by a processing component 820 of an electronic device 800 to implement the abovementioned method.

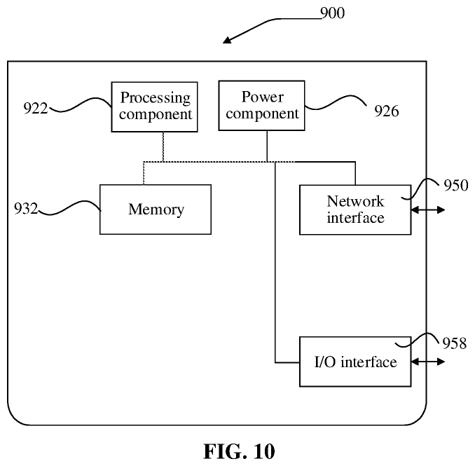

FIG. 10 illustrates a block diagram of an electronic apparatus 900 according to an exemplary embodiment. For example, the electronic device 900 may be provided as a server. Referring to FIG. 10, the electronic device 900 includes a processing component 922, further including one or more processors, and a memory resource represented by a memory 932, configured to store an instruction executable for the processing component 922, for example, an application program. The application program stored in the memory 932 may include one or more modules, with each module corresponding to one group of instructions. In addition, the processing component 922 is configured to execute the instruction to execute the abovementioned method. At this time, the localization unit is located at the cloud terminal.

The electronic device 900 may further include a power component 926 configured to execute power management of the electronic device 900, a wired or wireless network interface 950 configured to connect the electronic device 900 to a network and an I/O interface 958. The electronic device 900 may be operated based on an operating system stored in the memory 932, for example, Windows Server™, Mac OS X™, Unix™, Linux™, FreeBSD™ or the like.

In an exemplary embodiment, a nonvolatile computer-readable storage medium, for example, a memory 932 including a computer program instruction, is also provided. The computer program instruction may be executed by a processing component 922 of an electronic device 900 to implement the abovementioned method.

The present disclosure may be a system, a method and/or a computer program product. The computer program product may include a computer-readable storage medium, in which a computer-readable program instruction configured to enable a processor to implement each aspect of the present disclosure is stored

The computer-readable storage medium may be a physical device capable of retaining and storing an instruction used by an instruction execution device. The computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as an Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the present disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely or partially executed in a computer of a user, executed as an independent software package, executed partially in the computer of the user and partially in a remote computer, or executed completely in the remote server or a server. In a case involved in the remote computer, the remote computer may be connected to the user computer via an type of network including the LAN or the WAN, or may be connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instruction. The electronic circuit may execute the computer-readable program instruction to implement each aspect of the present disclosure.

Herein, each aspect of the present disclosure is described with reference to flowcharts and/or block diagrams of the method, device (system) and computer program product according to the embodiments of the present disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the present disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the present disclosure has been described above. The above descriptions are exemplary, non-exhaustive and also not limited to each disclosed embodiment. Many modifications and variations are apparent to those of ordinary skill in the art without departing from the scope and spirit of each described embodiment of the present disclosure. The terms used herein are selected to explain the principle and practical application of each embodiment or technical improvements in the technologies in the market best or enable others of ordinary skill in the art to understand each embodiment disclosed herein.

1. A method for localization based on a shared map, comprising:
extracting local map data associated with a key frame from global map data, comprising at least one key frame, of an image collected by a first terminal;
acquiring a present frame in an image collected by a second terminal; and
performing feature matching on the present frame and the local map data, and obtaining a localization result for the present frame according to a matching result.

2. The method of claim 1, wherein before acquiring the present frame in the image collected by the second terminal, the method further comprises: determining whether a number of feature points extracted from the present frame is smaller than an expected threshold for the feature matching, and triggering, in a case where the number of feature points extracted from the present frame is smaller than the expected threshold, processing of supplementing feature points to the present frame.

3. The method of claim 2, wherein the present frame collected by the second terminal comprises a present frame obtained by performing the processing of supplementing the feature points to the present frame.

4. The method of claim 2, wherein performing the processing of supplementing the feature points to the present frame comprises:
acquiring a first screening threshold for performing feature point extraction on the present frame; and
adaptively adjusting the first screening threshold according to reference information to obtain a second screening threshold, and supplementing feature points to the present frame according to the second screening threshold, such that the number of feature points is greater than a number of feature points acquired by actual collection.

5. The method of claim 4, wherein the reference information comprises at least one of: information in environmental information for image collection, parameter information in an image collection device, or image information of the present frame itself.

6. The method of claim 1, wherein performing the feature matching on the present frame and the local map data, and obtaining the localization result for the present frame according to the matching result comprises:
performing Two-Dimensional (2D) feature matching of feature points on the present frame and feature points on at least one key frame in the local map data to obtain a 2D feature matching result;
screening a 2D feature matching result comprising Three-Dimensional (3D) information from the 2D feature matching result, and extracting the 3D information; and
obtaining a pose of the present frame according to the 3D information, the pose of the present frame serving as the localization result.

7. A method for localization based on a shared map, comprising:
collecting, by a first terminal, an image to obtain global map data comprising at least one key frame;
extracting, by the first terminal, local map data associated with the key frame from the global map data; and
receiving, by the first terminal, a present frame collected by a second terminal, performing feature matching on the present frame and the local map data, obtaining a localization result for the present frame according to a matching result, and sending the localization result.

8. The method of claim 7, wherein extracting, by the first terminal, the local map data associated with the key frame from the global map data comprises:
taking, with the key frame as a reference center, map data, which is obtained according to the key frame and a preset extraction range, as the local map data.

9. The method of claim 7, wherein performing the feature matching on the present frame and the local map data, and obtaining the localization result for the present frame according to the matching result comprises:
performing Two-Dimensional (2D) feature matching of feature points on the present frame and feature points on at least one key frame in the local map data to obtain a 2D feature matching result;
screening a 2D feature matching result comprising Three-Dimensional (3D) information from the 2D feature matching result, and extracting the 3D information; and
obtaining a pose of the present frame according to the 3D information, and taking the pose of the present frame as the localization result.

10. A method for localization based on a shared map, comprising:
receiving, by a second terminal, global map data comprising at least one key frame, and extracting local map data associated with the key frame from the global map data;
collecting, by the second terminal, an image to obtain a present frame in the collected image; and
performing, by the second terminal, feature matching on the present frame and the local map data, and obtaining a localization result for the present frame according to a matching result.

11. The method of claim 10, wherein before collecting, by the second terminal, the image to obtain the present frame in the collected image, the method further comprises: determining whether a number of feature points extracted from the present frame is smaller than an expected threshold for the feature matching, and triggering, in a case where the number of feature points extracted from the present frame is smaller than the expected threshold, processing of supplementing feature points to the present frame.

12. The method of claim 11, wherein the present frame comprises a present frame obtained by performing the processing of supplementing the feature points to the present frame.

13. The method of claim 11, wherein performing the processing of supplementing the feature points to the present frame comprises:
acquiring a first screening threshold for performing feature point extraction on the present frame; and
adaptively adjusting the first screening threshold according to reference information to obtain a second screening threshold, and supplementing feature points to the present frame according to the second screening threshold, such that the number of feature points is greater than a number of feature points acquired by actual collection.

14. The method of claim 13, wherein the reference information comprises at least one of: information in environmental information for image collection, parameter information in an image collection device, or image information of the present frame itself.

15. The method of claim 10, wherein performing the feature matching on the present frame and the local map data, and obtaining the localization result for the present frame according to the matching result comprises:
performing Two-Dimensional (2D) feature matching of feature points on the present frame and feature points on at least one key frame in the local map data to obtain a 2D feature matching result;
screening a 2D feature matching result comprising Three-Dimensional (3D) information from the 2D feature matching result, and extracting the 3D information; and
obtaining a pose of the present frame according to the 3D information, taking the pose of the present frame as the localization result.

16. An electronic device, comprising:
a processor; and
a memory, configured to store an instruction executable for the processor, wherein the processor is configured to execute a method for localization based on a shared map, comprising:
extracting local map data associated with a key frame from global map data, comprising at least one key frame, of an image collected by a first terminal;
acquiring a present frame in an image collected by a second terminal; and
performing feature matching on the present frame and the local map data, and obtaining a localization result for the present frame according to a matching result.

17. The electronic device of claim 16, wherein before acquiring the present frame in the image collected by the second terminal, the method further comprises: determining whether a number of feature points extracted from the present frame is smaller than an expected threshold for the feature matching, and triggering, in a case where the number of feature points extracted from the present frame is smaller than the expected threshold, processing of supplementing feature points to the present frame.

18. The electronic device of claim 17, wherein the present frame collected by the second terminal comprises a present frame obtained by performing the processing of supplementing the feature points to the present frame.

19. The electronic device of claim 17, wherein performing the processing of supplementing the feature points to the present frame comprises:
acquiring a first screening threshold for performing feature point extraction on the present frame; and
adaptively adjusting the first screening threshold according to reference information to obtain a second screening threshold, and supplementing feature points to the present frame according to the second screening threshold, such that the number of feature points is greater than a number of feature points acquired by actual collection.

20. The electronic device of claim 19, wherein the reference information comprises at least one of: information in environmental information for image collection, parameter information in an image collection device, or image information of the present frame itself.
